(19) United States
(12) Patent Application Publication
(10) Pub. No.: US 2024/0246248 A1
(43) Pub. Date: Jul. 25, 2024

(54) ACTUATOR

(71) Applicant: KEIO UNIVERSITY, Minato-ku, Tokyo (JP)

(72) Inventors: Seiichiro KATSURA, Kanagawa (JP); Mariko SATO, Kanagawa (JP)

(73) Assignee: KEIO UNIVERSITY, Minato-ku, Tokyo (JP)

(21) Appl. No.: 18/561,674

(22) PCT Filed: May 17, 2022
(86) PCT No.: PCT/JP2022/020548

§ 371 Date: Jan. 2, 2024

(30) Foreign Application Priority Data
May 17, 2021 (JP) 2021-083338

(51) Int. Cl. B25J 18/00; H02K 21/16; H02K 21/24

(52) U.S. Cl. CPC B25J 18/00; H02K 21/16; H02K 21/24

(57) ABSTRACT

An object of the present disclosure is to provide an actuator that can be used for a multi-degree-of-freedom manipulator and can solve at least a part of a problem of reduction in backdrivability of a gear. Provided are an electric motor and an actuator. The electric motor comprises a stator and a rotor, wherein the electric motor comprises a first link in which a link part is provided in the stator and a second link in which a link part is provided in the rotor.

### TECHNICAL FIELD

The present invention relates to an actuator and a manipulator comprising the actuator.

### BACKGROUND ART

Recently, active involvement of robots in a variety of fields, such as an industry, medical treatment, and caregiving, is expected. Reasons include a labor shortage due to a declining birthrate and aging population, a movement aiming to highly efficient work, and the like. Robots having a plurality of degrees of freedom and being capable of performing dexterous movements are needed in a wide variety of fields, such as manipulators for the industry or the like and human supporting apparatuses. For example, there is a need for a multi-degree-of-freedom manipulator for industrial robot arms, artificial arms, and robot hands. Therefore, serial link manipulators in which motors are connected in series to achieve multi-degree-of-freedom have been developed.

Conventional manipulators have a structure of mounting a plurality of motors to a joint part in series. For example, Patent Literatures 1 to 9 describe conventional manipulators.

In link actuators used for conventional manipulators, the structure that is generally employed is one in which, when a motor is mounted, a shaft of a link and a shaft of the motor are connected with a member referred to as a coupling and the motor is mounted on the outside of the link. However, this configuration results in high inertia of the actuator and ultimately the manipulator comprising the actuator since the coupling is mounted on the outside of the link.

In some cases, the motor is not mounted on the outside of the link, but placed (disposed) inside the link and in such cases, a method of increasing the output torque while converting the rotation direction using a gear inside the link is generally used. Such conventional link actuators have problems, such as an increase in inertia due to separation of the link component from the motor component and a decrease in control accuracy due to use of a gear. Additionally, although the use of the gear (reducer) increases the torque, the rotation is at a low speed, and therefore conventional link actuators are not appropriate for situations where high speed movements are needed (for example, situations where a robot assists a human). Further, the use of a gear causes the problem of decrease in backdrivability, i.e., reverse movement capability. Furthermore, it was a problem that the gear itself causes an increase in the weight of the manipulator.

Additionally, in connection with the structure, when the motors were connected in series (serially) to increase the degree of freedom, this causes the problem of an increase in inertia when a distal end of the manipulator is moved. Furthermore, since the components of the motors and the link are separate components, the number of components increases. This becomes more problematic as the number of the links increases in, for example, multi-degree-of-freedom manipulators and serial link manipulators. With regard to multi-degree-of-freedom manipulators or the like, and in cases where multiple links are coupled, a larger torque is required close to the root part. Therefore, as a countermeasure, the motor size has been increased to handle the increased required torque for the actuator close to the root. However, there were limitations to such countermeasure. Furthermore, the increase in size of the motor resulted in a vicious cycle causing an increase in inertia when the link and the manipulator are moved.

### CITATION LIST

### Patent Literature

Patent Literature 1: WO 2007/037131 (Japanese Patent No. 5004020)

Patent Literature 2: JP 2012-56082 A (Japanese Patent Application No. 2011-283819)

Patent Literature 3: JP 2012-139770 A (Japanese Patent No. 5565756)

Patent Literature 4: JP 2009-154261 A (Japanese Patent Application No. 2007-336536)

Patent Literature 5: WO 2016/084178 (Japanese Patent No. 6443456)

Patent Literature 6: JP 2010-2538587 A (Japanese Patent Application No. 2009-104126)

Patent Literature 7: Japanese Patent No. 6820633

Patent Literature 8: JP 2019-42903 A (Japanese Patent Application No. 2017-171609)

Patent Literature 9: JP 2017-047492 A (Japanese Patent Application No. 2015-171595)

### SUMMARY OF INVENTION

### Technical Problem

As described above, while there is the need to make manipulators capable of multi-degree-of-freedom, the use of the gear was not a desirable solution due to the backdrivability problem and from the perspective of increase in weight. An object of the present invention is to provide an actuator or a manipulator that comprises the actuator that solves at least a part of the above-described problems.

### Solution to Problem

As a result of intense studies to solve the problems, and as an example, the present inventors have found that providing a first link in a stator of an electric motor and providing a second link in a rotor allow achieving an electric motor and actuator having inertia lower than that of conventional links and thereby completed the present invention encompassing the same as embodiments.

The present disclosure encompasses the following embodiments:
[1] An electric motor comprising a first link and a second link, wherein the first link comprises a stator and the second link comprises a rotor.
[2] The electric motor according to embodiment 1, wherein the rotor is placed inside the stator and the rotor rotates in the stator to move the first link relative to the second link, or
the stator is placed inside the rotor and the rotor rotates in the rotor to move the first link relative to the second link.
[3] The electric motor according to embodiment 1 or 2, wherein the motor is a radial gap motor.
[4] The electric motor according to embodiment 1 or 2, wherein the motor is an axial gap motor.
[5] An actuator comprising the electric motor according to any one of embodiments 1 to 4.
[6] The actuator according to embodiment 5, wherein an end part on the opposite side of the end part where the stator of the first link is present is fixed to another fixing part.
[7] The actuator according to embodiment 5, wherein an end part on the opposite side of the end part where the rotor of the second link is present is fixed to another fixing part.
[8] The actuator according to embodiment 5 or 6, wherein a second stator is provided on the end part on the opposite side of the end part where the rotor of the second link is present.
[9] The actuator according to embodiment 5 or 6, wherein a second rotor is provided on the end part on the opposite side of the end part where the rotor of the second link is present.
[10] The actuator according to embodiment 5 or 7, wherein a second stator is provided on the end part on the opposite side of the end part where the stator of the first link is present.
[11] The actuator according to embodiment 5 or 7, wherein a second rotor is provided on the end part on the opposite side of the end part where the stator of the first link is present.
[12] The actuator according to embodiment 8 or 10 comprising a third link that comprises a link part in the second rotor rotated by the second stator.
[13] The actuator according to embodiment 9 or 11 comprising a third link that comprises a link part in the second stator rotated by the second rotor.
[14] The actuator according to any one of embodiments 5 to 13, wherein the actuator according to any one of embodiments 5 to 13 is connected to another actuator in series.
[15] The actuator according to any one of embodiments 5 to 13, wherein the actuator according to any one of embodiments 5 to 13 is connected to another actuator in parallel.
[16] The electric motor according to any one of embodiments 1 to 4, wherein the electric motor does not comprise a gear or the actuator according to any one of embodiments 5 to 15, wherein the actuator does not comprise a gear.
[17] A method comprising using the electric motor according to embodiment 1, 2, 3, 4, or 16 or the actuator according to any one of embodiments 5 to 16.
[18] A method of manufacturing an electric motor that comprises a stator and a rotor, said method comprising:
providing a link part in the stator as a first link; and
providing a link part in the rotor as a second link.
[19] The manufacturing method according to embodiment 18, wherein the motor is a radial gap motor.
[20] The manufacturing method according to embodiment 18, wherein the motor is an axial gap motor.
[21] The manufacturing method according to any one of embodiments 18 to 20, wherein the electric motor does not comprise a gear.

The present specification encompasses contents disclosed in Japanese Patent Application No. 2021-083338 forming the basis for priority of this application.

### Advantageous Effects of Invention

As an effect (advantage) of the present invention, an electric motor and actuator having lower inertia compared to a conventional link are provided.

### BRIEF DESCRIPTION OF DRAWINGS

FIG. 1A illustrates a conventional actuator comprising a coupling.

FIG. 1B illustrates a conventional actuator that does not comprise a coupling but places the motor outside the link.

FIG. 1C illustrates an in-link actuator of the present disclosure.

FIG. 2 is a diagram illustrating an example of a stator link (first link) of the present disclosure (top view).

FIG. 3 is a diagram illustrating an example of the stator link (first link) of the present disclosure (perspective view).

FIG. 4 is a diagram illustrating an example of a rotor link (second link) of the present disclosure (top view).

FIG. 5 is a diagram illustrating an example of the rotor link (second link) of the present disclosure (perspective view).

FIG. 6 is a diagram illustrating an example of how to wind coils inside the in-link actuator of the present disclosure.

FIG. 7 is a photograph diagram of the stator link on which the coils are wound. The configuration merely an example.

FIG. 8 is a diagram illustrating an array of magnets. The configuration merely an example.

FIG. 9 is a photograph diagram of the rotor link of the present disclosure. The configuration merely an example.

FIG. 10A illustrates a device on which a mount for attaching the link actuator to a DD motor is mounted.

FIG. 10B depicts photograph diagrams of respective link actuators coupled to motors and bases. Comparative Example 1 is a conventional actuator comprising a coupling, Comparative Example 2 is a conventional actuator that does not comprise a coupling but places the motor outside of the link, and the present invention is the in-link actuator of the present disclosure.

FIG. 11 illustrates results of measuring the moment of inertia of the respective links. A conventional link comprising a coupling had the largest moment of inertia (left, Comparative Example 1). Additionally, a conventional actuator that does not comprise a coupling but has the motor placed outside of the link exhibited a certain moment of inertia (center, Comparative Example 2). In contrast, the actuator of the present disclosure exhibited a substantially reduced moment of inertia (right, the present invention).

FIG. 12 illustrates an example of a configuration in which a first actuator (the actuator of the present disclosure), a second actuator, and a third actuator are coupled in series.

FIG. 13 illustrates an example of a configuration in which the first actuator (the actuator of the present disclosure), the second actuator, and the third actuator are coupled in parallel.

FIG. 14 illustrates a block line diagram when velocity control is performed on a servomotor by a velocity controller.

FIG. 15A is a front view of an exemplary radial gap in-link actuator.

FIG. 15B is a back view of the exemplary radial gap in-link actuator.

FIG. 15C is a cross-sectional view of the exemplary radial gap in-link actuator.

FIG. 15D is a cross-sectional view of the exemplary radial gap in-link actuator.

FIG. 16A is a front view of an exemplary radial gap in-link actuator in which a shaft is integrated with a rotor link.

FIG. 16B is a back view of the exemplary radial gap in-link actuator in which the shaft is integrated with the rotor link.

FIG. 16C is a cross-sectional view of the exemplary radial gap in-link actuator in which the shaft is integrated with the rotor link.

FIG. 16D is a cross-sectional view of the exemplary radial gap in-link actuator in which the shaft is integrated with the rotor link.

FIG. 17A is a front view of an exemplary axial gap in-link actuator.

FIG. 17B is a cross-sectional view of the exemplary axial gap in-link actuator.

FIG. 17C is a cross-sectional view of the exemplary axial gap in-link actuator.

FIG. 17D is a cross-sectional view of the exemplary axial gap in-link actuator.

FIG. 17E illustrates a rotation angle of the axial gap in-link actuator. With this configuration, a rotor is rotatable to the right and left.

FIG. 17F illustrates a rotation angle of the axial gap in-link actuator.

### DESCRIPTION OF EMBODIMENTS

In one embodiment, the present disclosure provides an electric motor comprising a stator and a rotor, wherein the electric motor comprises a first link in which a link part is provided in the stator, and a second link in which a link part is provided in the rotor. In other words, in one embodiment, the present disclosure provides an electric motor comprising a stator having a first link and a rotor having a second link. Further, in other words, this configuration can be rephrases as an electric motor comprising the first link comprising a stator and a second link comprising a rotor. In one embodiment, the present disclosure provides an electric motor in which the rotor is placed (provided) inside of the stator and the rotor rotates inside the stator to move the first link relative to the second link, or the stator is placed (provided) inside of the rotor and the rotor rotates inside the rotor to move the first link relative to the second link. Thus, an electric motor and a link are both actualized (achieved) within the same structure. In other words, the link and the actuator are integrated. In the actuator of the present disclosure, the link is provided in the electric motor instead of the electric motor being mounted on the outside of the link. For convenience, such electric motor or link may be referred to herein as an in-link actuator. In contrast, for convenience, a conventional actuator in which the motor is placed on the outside of the link may be referred to herein as an out-link actuator.

The electric motor comprises a stator and a rotor. The stator is also referred to as a stationary part and is a member of the electric motor that is to be fixed. In other words, the stator is a fixed armature or a field magnet of an electric motor. The rotor is also referred to as a rotating part and is a rotating magnetic field or armature of the electric motor. Usually, the rotor rotates a shaft to transmit the rotational force. The rotor may be of a squirrel cage shape, a special squirrel cage shape, a winding shape, and a permanent magnet shape, but is not limited thereto. The rotor may be an inner rotor, an outer rotor, or a flat rotor. With regard to the electric motor of the present disclosure, the first link is provided in the stator and the second link is provided in the rotor. In the present specification, for convenience, the second link in which the link part is provided in the rotor may be referred to as a rotor link. Further, in the present specification, for convenience, the first link in which the link part is provided in the stator may be referred to as a stator link. However, this is merely an expression for convenience when the first link and the second link are regarded as a set and this does not preclude placing (providing) another rotor or stator in the rotor link and does not preclude placing (providing) another stator or rotor in the stator link. For example, in one embodiment, a second rotor may be placed on the side of the stator link (first link) where the stator is not present. Here, the electric motor constituted by the stator link (first link) and the rotor link (second link) is designated as the first electric motor (or first actuator), and the electric motor constituted by the second rotor and the other second stator is designated as the second electric motor (or second actuator). In this case, the first link can be understood as being the stator link when viewed from the first electric motor side and can be understood as being the rotor link when viewed from the second electric motor side.

The side of the first link where the stator is not present may be fixed to another fixing part. That is, in one embodiment, the present disclosure provides an actuator in which the side of the first link where the stator is not present is fixed to another fixing part. Additionally, the side of the second link where the rotor is not present can be fixed to another fixing part. That is, in one embodiment, the present disclosure provides an actuator in which the side of the second link where the rotor is not present is fixed to another fixing part. Here, the fixing part refers to a fixing part that is fixed itself and immovable or a fixing part that moves itself, for example, a fixing part that moves or rotates. That is, a fixing part does not mean that the fixing part itself is fixed, and as long as the fixing part fixes the link, any fixing part may be used.

Furthermore, on the side of the second link where the rotor is not present, the second stator may be placed or the second rotor may be placed. That is, in one embodiment, the present disclosure provides an actuator in which the second stator is placed on the side of the second link where the rotor is not present. Additionally, in one embodiment, the present disclosure provides an actuator in which the second rotor is provided (placed) on the side of the second link where the rotor is not present. Conversely, on the side of the first link where the stator is not present, the second stator may be placed or the second rotor may be placed. That is, in one embodiment, the present disclosure provides an actuator in which the second stator is placed on the side of the first link where the stator is not present. Additionally, in one embodiment, the present disclosure provides an actuator in which the second rotor is placed on the side of the first link where the stator is not present. In the present specification, the side of the link where the stator is not present may be referred to as an end part on the opposite side of the end part where the stator is present. Additionally, the side of the link where the rotor is not present may be referred to as an end part on the opposite side of the end part where the rotor is present.

When the second stator is provided, a third link that comprises a link part on the second rotor rotated by the second stator may be further coupled. That is, in one embodiment, the present disclosure provides an actuator that comprises a third link that comprises a link part in the second rotor rotated by the second stator. In another embodiment, the present disclosure provides an actuator that comprises a third link that comprises the link part in the second stator rotated by the second rotor.

The actuator of the present disclosure may use any electric motor. The electric motor includes DC electric motors (DC motor), AC electric motors (AC motor), induction electric motors (induction motor, IM), and synchronous electric motors (synchronous motor, SM). The DC electric motor includes, without limitation, DC commutator motors, permanent magnet field type commutator motors, electromagnetic field type commutator motors, and commutatorless motors. The DC electric motor may be an inner rotor type or an outer rotor type. The DC electric motor may be a motor with brush or a brushless motor, or a stepping motor. The AC electric motor includes, without limitation, an induction electric motor and a synchronous electric motor. The induction electric motor includes, without limitation, a single-phase induction motor, a three-phase induction motor, and the like. The synchronous electric motor includes, without limitation, an electromagnetic synchronous motor, a permanent magnet synchronous motor, a reluctance type synchronous motor, and a hysteresis type synchronous motor.

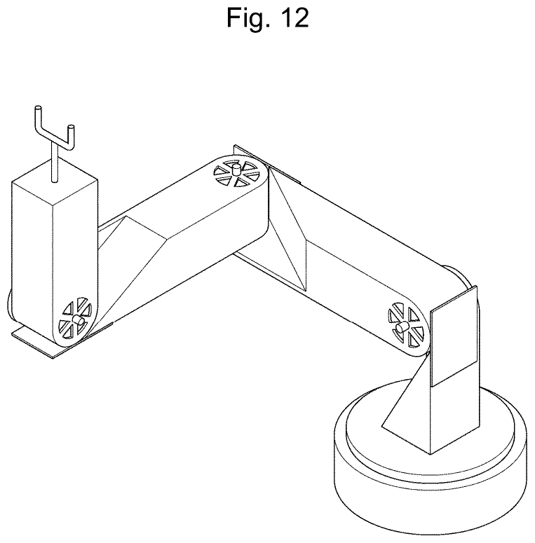

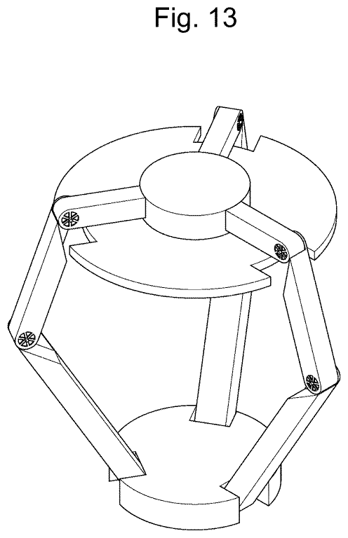

The actuator of the present disclosure may be used for a manipulator. That is, in one embodiment, the present disclosure provides an actuator that comprises an electric motor comprising a stator and a rotor, wherein the electric motor comprises a first link in which the link part is provided in the stator and a second link in which the link part is provided in the rotor. Additionally, in one embodiment, the present disclosure provides a manipulator that comprises the actuator. The manipulator may comprise one actuator or may comprise two or more actuators. In the present specification, a manipulator comprising two or more actuators may be referred to as a multi-degree-of-freedom manipulator. In one embodiment, a multi-degree-of-freedom manipulator that comprises one or more actuators of the present disclosure (first actuators) and one or more other actuator(s) (second actuator) is provided. The second actuator is an expression for convenience and may be a conventional actuator or an actuator of the present disclosure. In one embodiment, the first actuator is serially coupled to the second actuator. In another embodiment, the first actuator is coupled to the second actuator in parallel. Likewise, the third, fourth, fifth, . . . , and n-th actuator(s) may be coupled serially (in series) and/or in parallel (n is a natural number). FIG. 12 illustrates an example of a serial configuration (n=3 in the example). FIG. 13 illustrates an example of a parallel configuration (n=2/2/2 in the example).

In another embodiment, a method of using the electric motor, the actuator, or the manipulator of the present disclosure is provided. In this method, the electric motor is electrically controlled to rotate the actuator. That is, in one embodiment, the manipulator of the present disclosure may comprise components of conventional manipulators. For example, the manipulator of the present disclosure may comprise a control mechanism or a controller, a wiring, a sensor, and the like.

In another embodiment, the present disclosure provides a method for manufacturing an electric motor comprising a stator and a rotor, wherein the stator has a link part and is configured as the first link and the rotor has a link part and is configured as the second link. In another embodiment, the present disclosure also provides a method for manufacturing the actuator comprising an electric motor and a method for manufacturing a manipulator comprising the actuator. In another embodiment, the present disclosure provides a method for manufacturing a multi-degree-of-freedom manipulator comprising a plurality of the actuators said method comprising a step of coupling the manufactured actuator to another actuator.

Employing the structure of the present disclosure enables decreasing the inertia of the entire link actuator. This reduction of inertia further exerts advantages (effects) when a multi-degree-of-freedom actuator is configured using the link actuator of the present disclosure. For example, when constituting two link actuators, it is possible to reduce the torque required to drive one link. When the required torque is reduced, this also reduces the weight of the required magnet and the amount of coil, leading to weight reduction of the motor part. As such, the inertia of the two link actuators is also reduced. Furthermore, for example, to increase the degree of freedom, when 3, 4, 5, . . . n (n is a natural number) links are coupled, the inertia can likewise be reduced and therefore this is further advantageous. In addition, the number of components of the in-link actuator is reduced compared to those of conventional link actuators. Conventional link actuators require a link, a motor, a shaft of the link, and a coupling. The in-link actuator of the present disclosure comprises the motor within the link, and the shaft of the motor is a common shaft shared with the shaft of the link, and therefore the coupling is unnecessary. This reduces the number of components used in the link actuator.

Unless stated otherwise, the electric motor of the present disclosure does not comprise a gear (namely, a reducer) connected to the motor part. Unless stated otherwise, the actuator of the present disclosure does not comprise a gear. It should be noted that this is with regard to an actuator of the present disclosure and is not with regard to the entire device. For instance, when the actuator of the present disclosure is incorporated into a multi-degree-of-freedom manipulator, this does not mean that the entire multi-degree-of-freedom manipulator including another actuator shall not comprise a gear. Instead, this means that the actuator part of the present disclosure in the multi-degree-of-freedom manipulator does not comprise a gear, while another part (which may include a conventional actuator) of the multi-degree-of-freedom manipulator may comprise a gear. That is, in a case where the actuator of the present disclosure is incorporated into a multi-degree-of-freedom manipulator, a configuration in which the actuator of the present disclosure (first actuator) does not comprise a gear, but another actuator (second actuator) comprising a gear is also provided in the present disclosure. Furthermore, a multi-degree-of-freedom manipulator that comprises an actuator of the present disclosure (first actuator) that does not comprise a gear and another actuator of the present disclosure (second actuator) that does not comprise a gear is also provided.

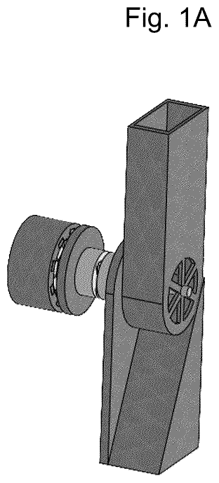

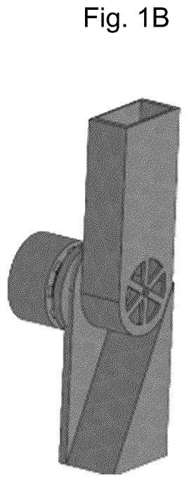

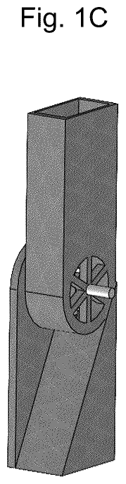

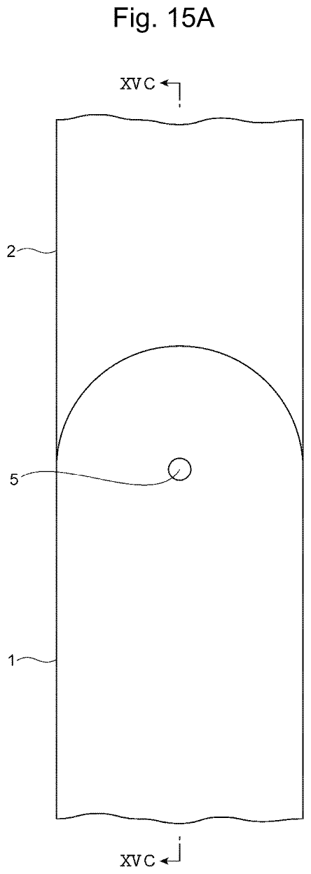

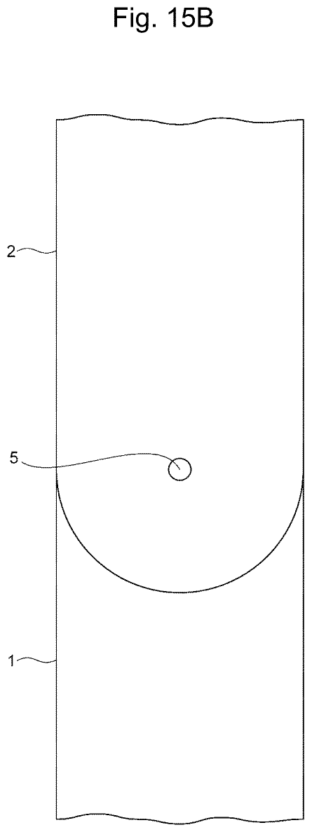

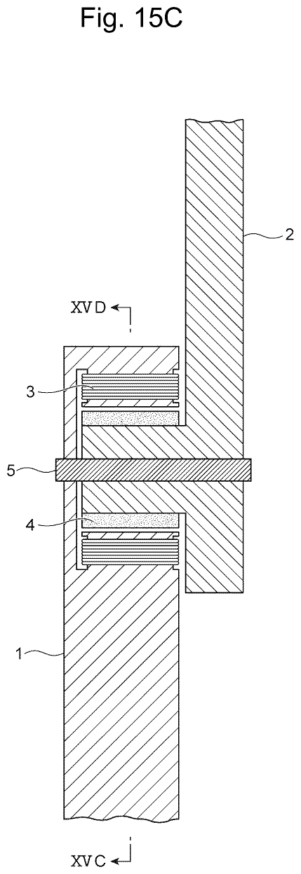

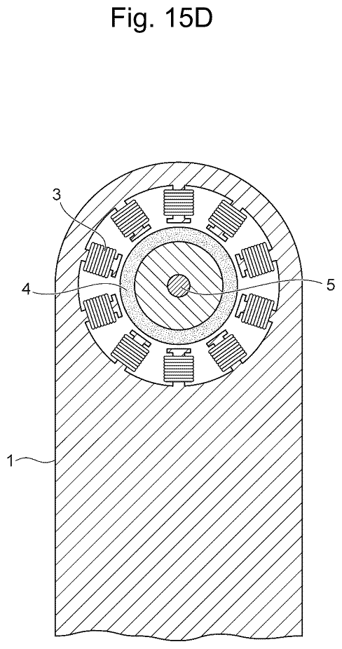

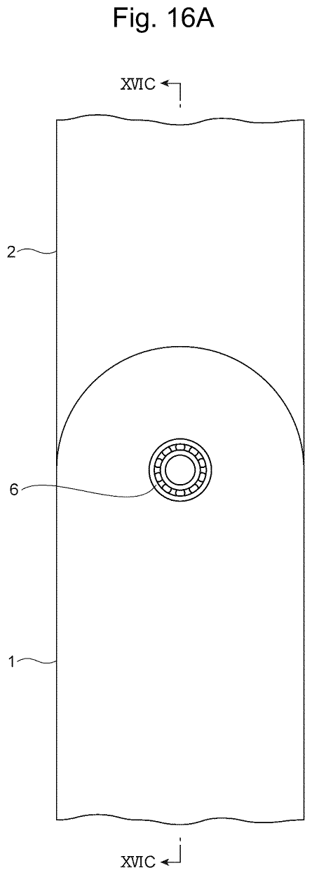

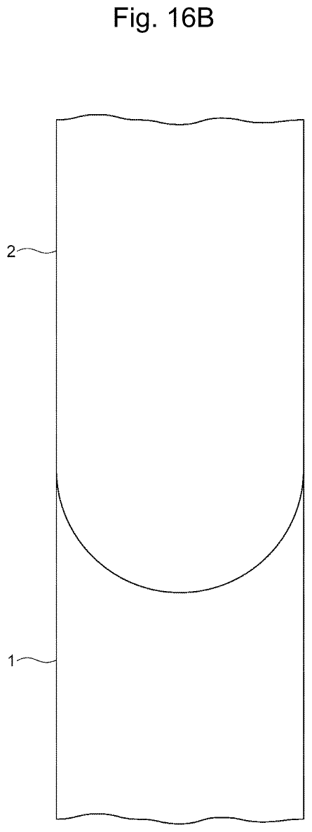

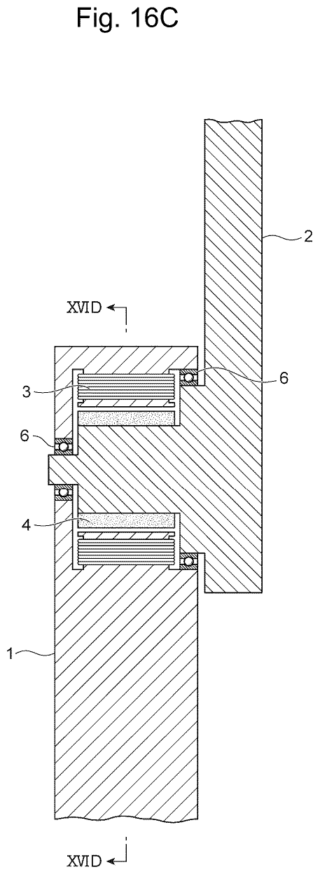

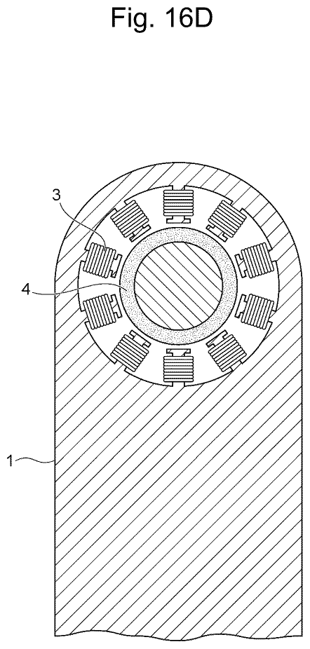

In one embodiment, the present disclosure provides a radial gap in-link actuator. The radial gap in-link actuator comprises a radial gap motor. A radial gap motor is configured such that a gap between the rotor and the stator forms a radial pattern from a plane where the rotation axis rotates (that is, the gap is parallel to the rotation axis). The in-link actuator in FIG. 1C is an example of a radial gap in-link actuator. Furthermore, FIG. 15A to FIG. 15D illustrate an example of a radial gap in-link actuator. While the diagrams indicate the magnet part as a circle, the magnet part may have any number n of magnets (for example, n=2, 3, 4 . . . , here, n is any natural number of two or more). Additionally, the magnet of the magnet part may be placed appropriately. The coil of the coil part is in an exemplary position. The coil part may have any number m of coils (for example, m=2, 3, 4 . . . , here, m is any natural number of two or more). Additionally, in the configuration, the shaft can be integrated with the rotor link. FIG. 16A to FIG. 16C illustrate an example of a radial gap in-link actuator in which the shaft is integrated with the rotor link. The rotor link integrated with the shaft may be manufactured with, for example, a 3D printer. However, the method for manufacture is not limited to this.

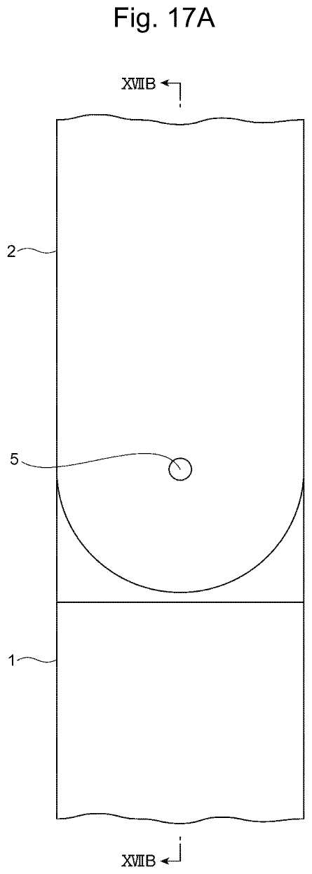

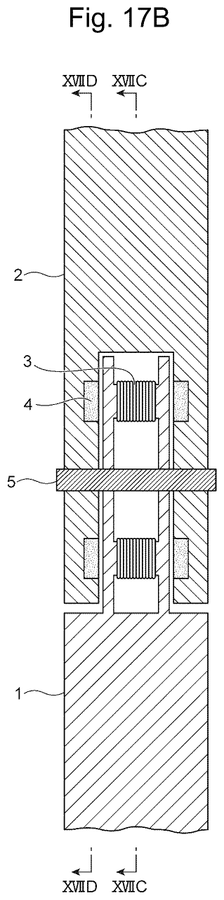

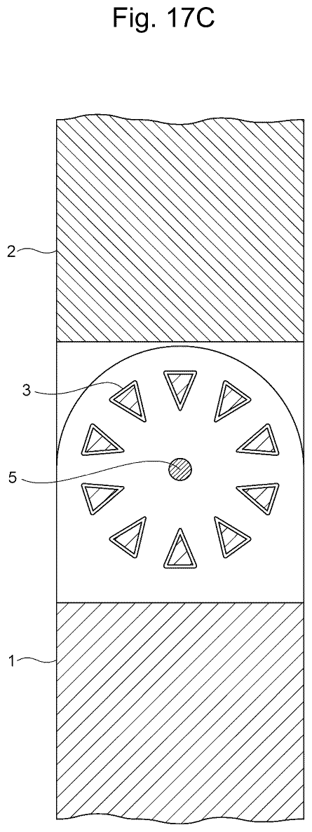

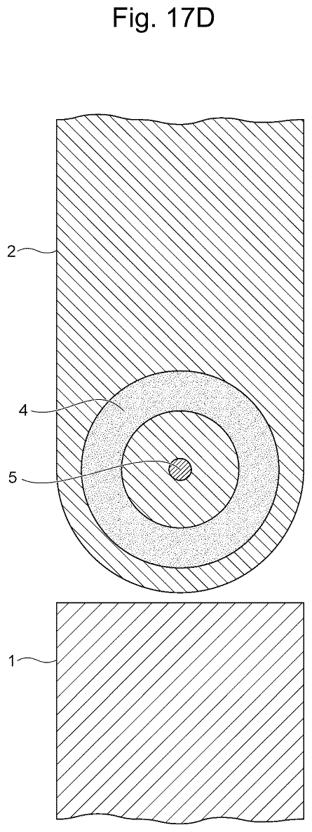

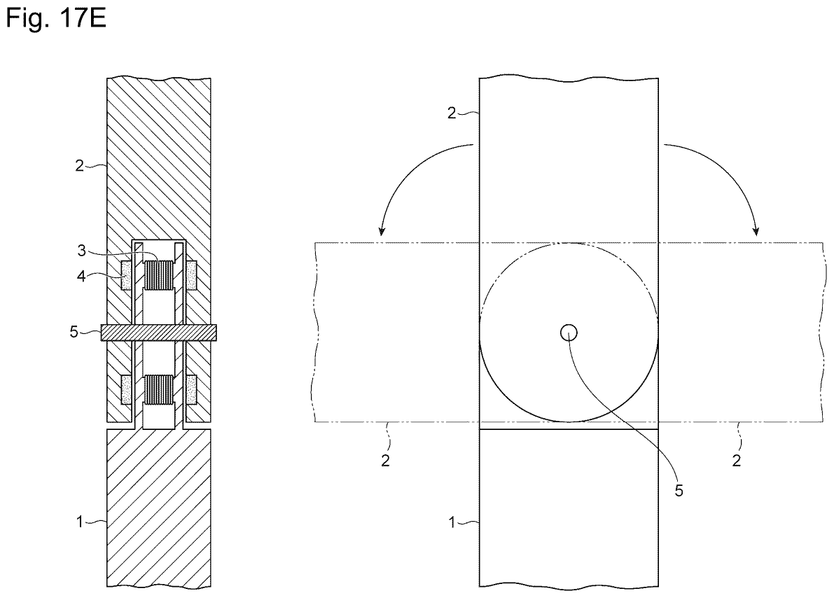

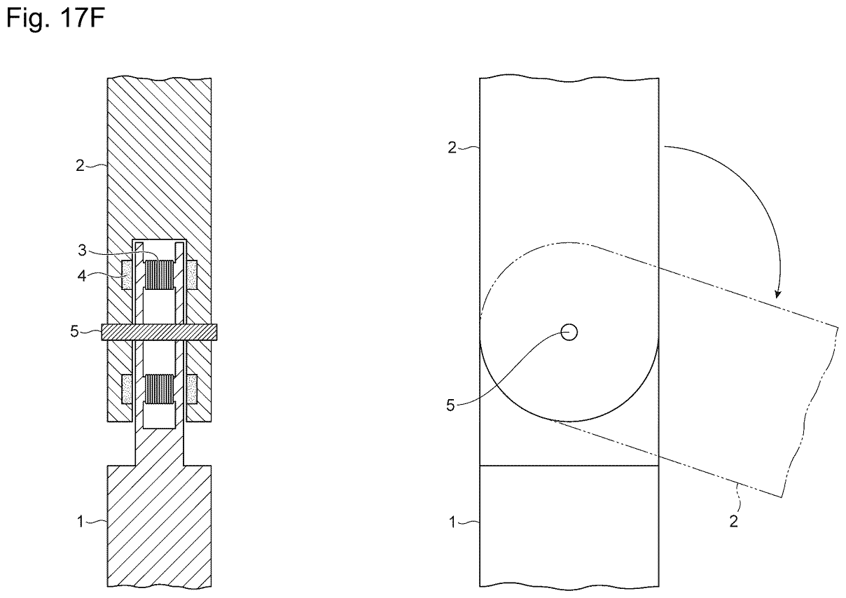

In another embodiment, the present disclosure provides an axial gap in-link actuator. The axial gap in-link actuator comprises an axial gap motor. An axial gap motor is also referred to as an axial flux motor or a pancake motor. In an axial gap motor, the gap between the rotor and the stator is configured so as to be parallel to the plane that the rotation axis rotates (i.e., the gap is perpendicular to the rotation axis). This geometry facilitates thinning of the axial gap motor. Additionally, the stator or the rotor can be embedded into a link. FIG. 17A to FIG. 17D illustrate an example of an axial gap in-link actuator. While the diagrams indicate the magnet part with a circle, the magnet part may have any number n of magnets (for example, n=2, 3, 4 . . . , here, n is any natural number of two or more). Additionally, the magnet of the magnet part may be placed appropriately. The coil of the coil part is in an exemplary position. The coil part may have any number m of coils (for example, m=2, 3, 4 . . . , here, m is any natural number of two or more). FIG. 17B illustrates an example of a configuration in which both sides of the coil are supported by the stator. However, the position of the coil is not limited thereto. For example, two sets of coils may be placed on both sides of the stator (that is, an upper surface and a lower surface of the rotary disc at the center).

Additionally, in a specific embodiment, positions of the magnet and the coil in FIG. 15A to FIG. 15D, FIG. 16A to FIG. 16C, and FIG. 17A to 17F may be interchanged. For example, in FIG. 15C, when the magnet and the coil are interchanged, the stator link 1 comprises a magnet part 4 and the rotor link 2 comprises a coil part 3. The same applies to FIG. 16C. The same applies to FIG. 17B. The present disclosure encompasses such aspects.

FIG. 17E and FIG. 17F illustrate the rotation angle of the rotor of an axial gap in-link actuator. The rotor in the configuration of FIG. 17E is rotatable to the right and left. As illustrated in FIG. 17F, when the stator link has a shape in which part of the link is removed, the rotation angle of the rotor can be increased. Conversely, it is also possible to restrict the rotation angle of the rotor. By processing the shape of the stator link and/or the rotor link, the movable range of the rotor link can be designed to be in the range of interest.

In specific embodiments, and with regard to various electric motors and actuators disclosed in the present specification, the motor can be a radial gap motor. In other embodiments, and with regard to various electric motors and actuators disclosed in the present specification, the motor can be an axial gap motor.

### EXAMPLES

To make the features of the actuator of the present disclosure more apparent, a conventional actuator will be described first.

### Comparative Example 1—an Actuator Including a Coupling

In conventional link actuators, a procedure is employed in which the motor is mounted outside the joint part of a link. When the motor is mounted on the outside of the joint part of the link, it is necessary to couple the link component and the motor, and, therefore, the shaft of the link and the shaft of the motor are connected by a coupling. FIG. 1A illustrates an example of such configuration.

### Comparative Example 2—an Actuator that does not Include a Coupling but Comprises a Motor Outside the Link

For precise force control, it is preferable not to use a gear. Therefore, as a link that does not use a gear, a conventional method mounts a motor on an outside of the joint part of a link. FIG. 1B illustrates an example of such configuration.

Actuator of the Present Disclosure (in-Link Actuator)

In the present disclosure, a coupling is not used and a common shaft serves as the shaft of the link and the shaft of the motor. FIG. 1C illustrates a model of this link actuator. That is, the link of the present disclosure does not comprise a coupling. In the link of the present disclosure, the motor is not mounted on the outside of the link but is placed inside the link.

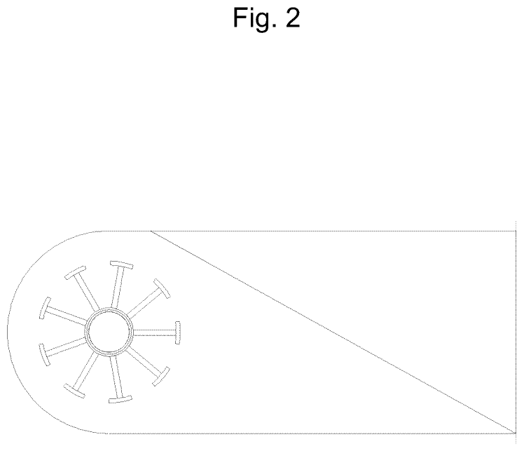

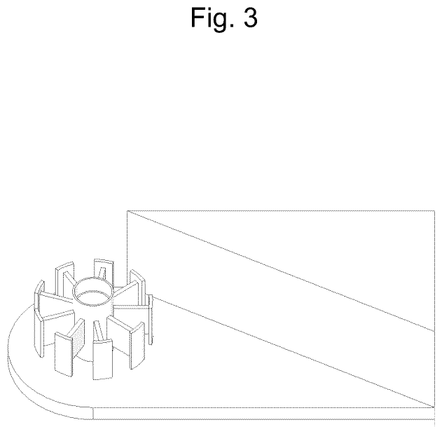

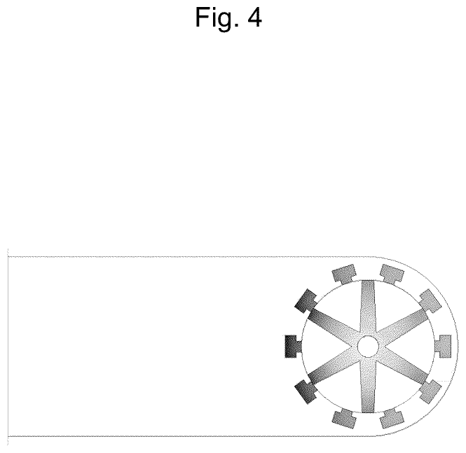

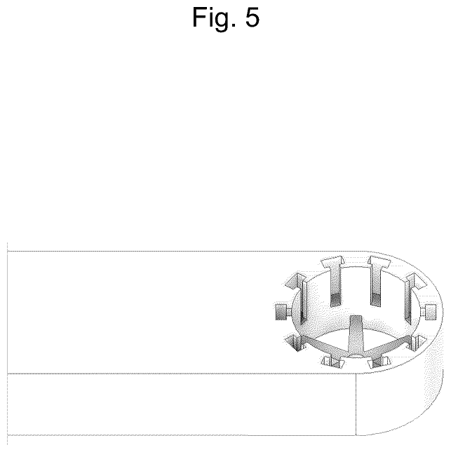

A manufacturing example of the actuator of the present disclosure will be described. Here, as an example, a brushless DC motor is embedded inside the link. The specific structure is such that, in a one-degree-of-freedom link, a distal end of one part of the link and the stator of the motor are integrated as a structure (stator link), and a distal end of the other part of the link and the rotor of the motor are integrated as a structure (rotor link). FIG. 2 illustrates a top view of a model of the stator link and FIG. 3 illustrates a perspective view. Additionally, FIG. 4 illustrates a top view of a model of the rotor link, and FIG. 5 illustrates a perspective view.

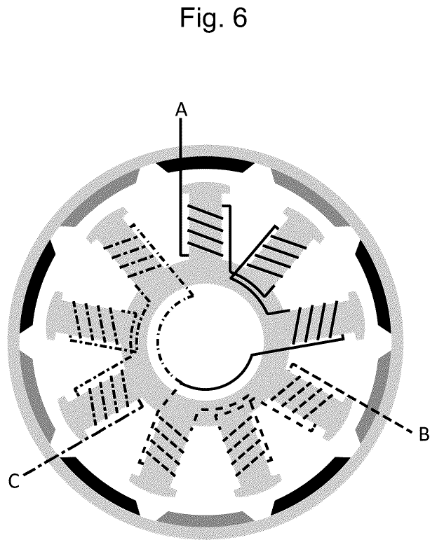

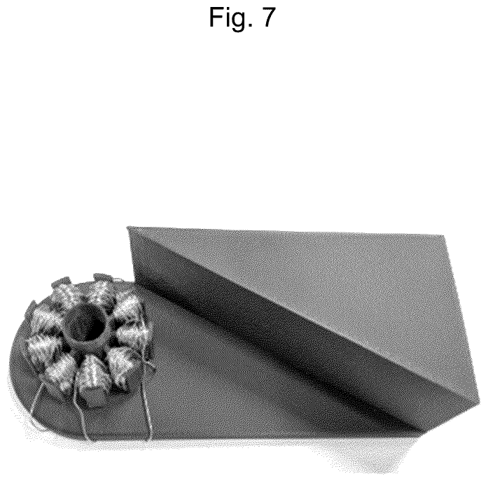

The exemplary stator at the distal end of the manufactured link had nine slots. FIG. 6 illustrates an exemplary winding of the nine-slot coil. Three coils are wound around nine slots. As the way of winding, the coil is wound around the first slot clockwise from a part denoted as A, and subsequently the coil is wound around the adjacent slot counterclockwise. The coil is then wound around the third slot clockwise. This way of winding is similarly applied to B and C. Terminating ends on one side of the three coils are collectively connected to one and a current may flow through the terminating ends at the other side. FIG. 7 illustrates the result of winding the coils on the stator link using this method. The number of slots of the stator is not limited to this, and when three coils are used, the slots may be 6 slots, 12 slots, and the like. Additionally, when 2 coils are used, the slots may be 2 slots, 4 slots, 6 slots, 8 slots, 10 slots, 12 slots, and the like, but the slots are not limited thereto.

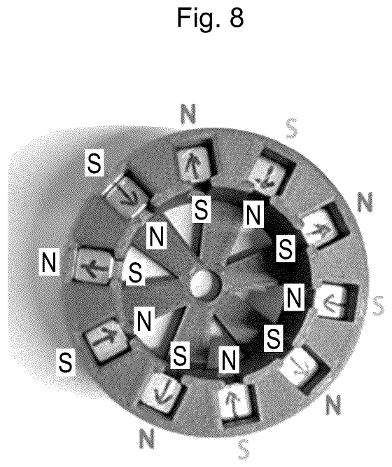

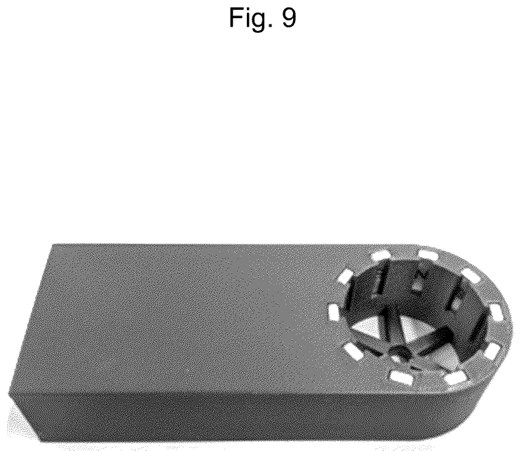

On the other hand, the rotor link was designed to have 10 poles. FIG. 8 illustrates the way of arranging the magnets to the rotor. As illustrated in FIG. 8, an NS array was employed in which NS poles of the magnets are placed alternatingly. The arrows in the drawing are illustrated from the S poles to the N poles. FIG. 9 illustrates the result of embedding the magnets into the rotor link using this arranging method of magnets. The number of poles and the positions of the magnets are not limited to this arrangement, and the magnets may be designed appropriately corresponding to the coils.

FIG. 1C illustrates an example of a stator link and a rotor link combined into a one link actuator. By adapting this structure, the link component and the motor component are not considered separately, and the joint part of the link itself can exert the driving function. While the rotor is placed at the outer part of the link, and the stator is placed at the inner part of the link part in the exemplary configuration, the actuator of the present disclosure is not limited thereto. For example, the rotor may be placed in the inner part of the part and the stator may be placed in the outer part of the link part.

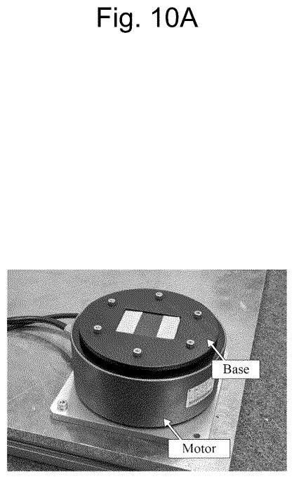

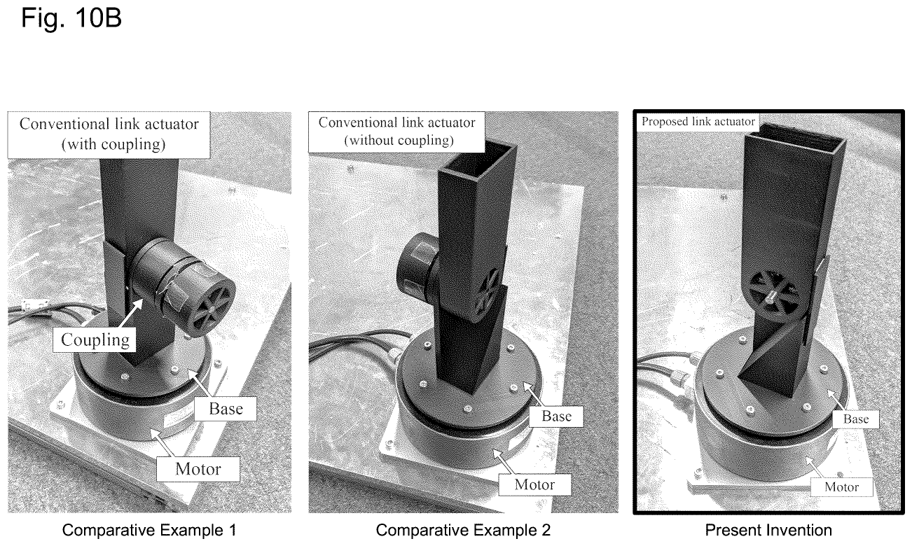

Next, a difference of the inertia between the in-link actuator of the present disclosure and a conventional out-link actuator was measured. To evaluate the moment of inertia, three types of actuators were placed to stand perpendicularly, and each of the actuators was coupled to a base such that the actuator performed a rotational motion (yawing) when viewed from the Z-axis direction. The base is coupled to a motor, and when the motor is driven, the base rotates. FIG. 10A and FIG. 10B illustrate these configurations.

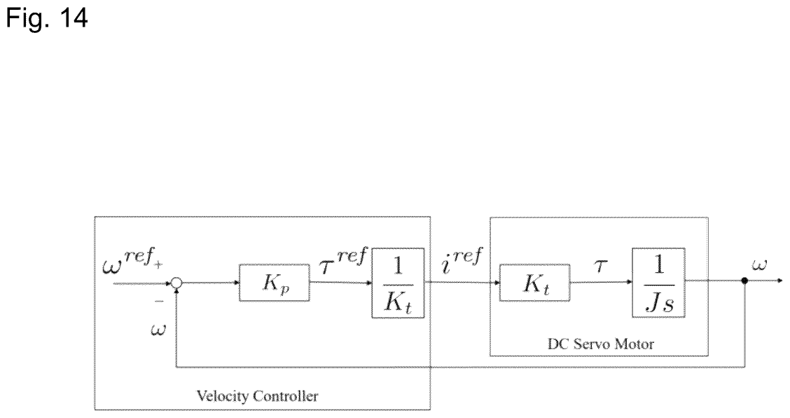

Next, the motor coupled to the base was driven to rotate the base, and the moment of inertia of the three types of actuators were measured. First, a method of measuring the moment of inertia of the motor by controlling the motor by a velocity controller will be described. In this experiment, the moment of inertia of the link actuator was measured using this method. FIG. 14 illustrates a block line diagram when velocity control is performed on a servomotor by a velocity controller. ω^{ref} indicates a velocity reference value, ω indicates a velocity response value, τ^{ref} indicates a torque reference value, τ indicates an output torque, i^{ref} indicates a current reference value, Kₚ indicates a proportional gain, Kₜₙ indicates a nominal value of the torque constant of the motor, Kₜ indicates the torque constant of the motor, J indicates the moment of inertia of the servomotor, and s is the Laplace operator. In this experiment, it is assumed that the torque constant does not vary and Kₜ is treated as being equal to Kₜₙ.

The system of FIG. 14 is a primary delay system, and the following shows Laplace transform f(s) and a time constant T of the step response.

$$f ( s ) = \frac{K}{1 + Ts} \cdot \frac{1}{s} \qquad [ Mathematical formula 1 ]$$

$$T = \frac{J}{Kp} \qquad [ Mathematical formula 2 ]$$

As described above, the time constant T is obtained from data of a steady value and a response value. The steady value and the response value of the velocity can be measured from an encoder mounted on the motor. By inputting the measured and obtained time constant T and the set proportional gain Kₚ into Formula (2), the moment of inertia of the servomotor can be obtained.

### Setup and Experimental Method

The motor used in this experiment is an Alternating Current (AC) direct drive servomotor (SGMCS-02BDC41; Yaskawa) (hereinafter, a DD motor). The DD motor is driven by a dedicated driver (SGDV2RIF: Yaskawa). Additionally, the DD motor comprises an encoder having a resolution of 20 bits. A controller of the DD motor is mounted on a general-purpose calculator comprising an Intel Core™ i7-870 (Intel Corp.) processor. The program is executed on Linux (registered trademark) v.26.32.2 on which Realtime Application Interface (RTAI3.7) has been installed. The controller is called at a cycle of 10 KHz.

Additionally, the mount and each link actuator were manufactured using a 3D printer (Mark Two: Markforged Inc.). Onyx was used as the filament.

Next, the experimental method is described. First, FIG. 10A illustrates a device on which a mount for mounting the link actuator is placed on the DD motor. A step input of velocity (the command value was 3.14 rad/s) was input to the DD motor, and the time constant was measured from the response value. By using the above-described method, the entire moment of inertia J_{m+b} including the DD motor and mount around the rotation axis of the DD motor is determined. A conventional link and the link actuator of the present disclosure are placed on the mount. The command value of the velocity is input as described above, and the moment of inertia Jₐₗₗ including the DD motor, the mount, and the link actuator around the rotation axis of the DD motor is obtained.

The moment of inertia J_{act} of the link actuator around the rotation axis of the DD motor is obtained from Formula (3). In the present experiment, the proportional gain Kₚ was set as 0.1.

$${J}_{act} = {J}_{all} - {J}_{m + b} \qquad [ Mathematical formula 3 ]$$

In this experiment, the moment of inertia of the three types of link actuators was determined. In the first configuration, the shaft of the link and the shaft of the motor are connected with a coupling.

In this experiment, to make performance of the driving part identical to that of the motor in the link actuator of the present disclosure, the motor was manufactured with conditions (such as size, magnet and coil, and number of turns of the coil) similar to conditions of the motor embedded into the inside of the link actuator of the present disclosure. In the left of FIG. 10B, the coupling is covered with a component of the 3D printer. This component is for connecting the stator of the motor to one side of the link to transmit rotation of the motor to the link. In the center of FIG. 10B, the link actuator mounted in the first configuration is improved, and the link and the motor have a common shaft. This improvement allows decreasing the inertia of the entire link actuator. The right in FIG. 10B is the in-link actuator of the present disclosure.

FIG. 10B illustrates devices on which the three types of link actuators are mounted. For the procedure, measurements were performed 10 times per each one link actuator, and the average was used to obtain the moment of inertia.

### Experimental Results and Examinations

The masses of the respective link actuators manufactured in this experiment were 0.194 kg for the conventional method (with coupling), 0.137 kg for the conventional method (without coupling), and 0.117 kg for the link actuator of the present disclosure.

It can be recognized that the mass is large in the descending order from the conventional method (with coupling) (largest), the conventional method (without coupling), and the link actuator of the present disclosure (smallest). Reasons include the presence of the coupling in the conventional method (with coupling) and the use of the two shafts. Additionally, in the case of the conventional method (without coupling), the component of the motor is provided separately from the link, and therefore the mass is larger compared to the proposed method.

Experiments in the case of only the DD motor and the mount, and the three types of respective link actuators were conducted 10 times. As a result, the response speed was fast in the order from the DD motor and the mount, the link actuator of the present disclosure, the conventional link (without coupling), and the conventional link (with coupling). Accordingly, it can be recognized that the moment of inertia around the rotation axis of the DD motor is small in the same order.

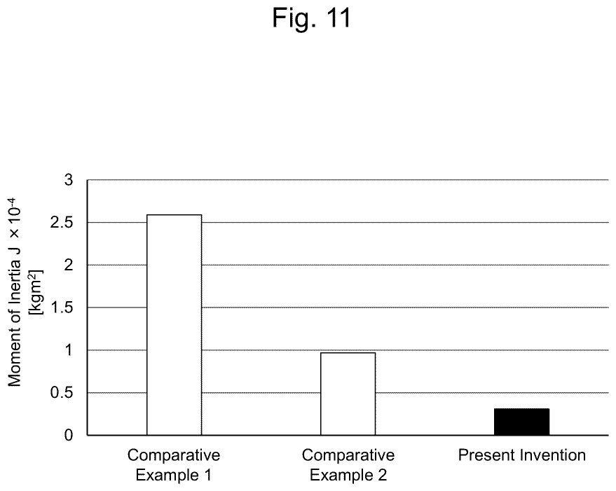

Further, FIG. 11 illustrates the moment of inertia. The conventional actuator having a coupling (the left in FIG. 10B) had the largest moment of inertia. Further, a certain amount of moment of inertia was observed in the conventional actuator not comprising a coupling but with the motor placed outside the link (the center in FIG. 10B). In contrast, the in-link actuator of the present disclosure (the right in FIG. 10B) exhibited a substantially reduced moment of inertia. More specifically, the actuator of the present disclosure exhibited a reduced moment of inertia reduced by 88% compared with the conventional actuator having a coupling and a moment of inertia reduced by 68% compared with the conventional actuator that does not comprise a coupling but with the motor placed outside the link.

A prototype in-link actuator comprising a radial gap motor as illustrated in FIG. 15A to FIG. 15D was produced. This has a configuration in which a stator link 1 comprises the coil part 3, and a rotor link 2 comprises the magnet part 4.

Next, a prototype radial gap in-link actuator in which the shaft is integrated with the rotor link illustrated in FIG. 16A to FIG. 16C was produced. In this configuration, the stator link 1 comprises the coil part 3, and the rotor link 2 comprises the magnet part 4. Further, the shaft and the rotor link are integrated, and therefore the rotor link 2 serves as the shaft. A bearing 6 can be placed between the stator link 1 and the rotor link 2. Integrating the shaft with the rotor link allows reducing the number of components. Further, the weight can be reduced.

Next, a prototype in-link actuator comprising an axial gap motor as illustrated in FIG. 17A to FIG. 17F was produced. By adapting an axial gap motor, the motor can be made thin. Further, in the case of an axial gap in-link actuator, the rotor link can be placed immediately above the stator link as viewed in the side diagram (see FIG. 17B). Therefore, compared with radial gap in-link actuators, an axial gap in-link actuator can further reduce the moment of inertia thereof.

The method of placing the motor in the link may have a drawback that the outer diameter of the link itself increases. Therefore, it is presumed that, when designing conventional actuators, the design of providing the motor inside of the link was not considered or this was difficult to be adapted.

In the present disclosure, the stator and the rotor of the motor were each embedded into the link, and separated into the stator link serving as the stator and the rotor link serving as the rotor. The present disclosure shows that by combining these two links, the link itself can function as the actuator without attaching a motor as a separate component. Additionally, it is demonstrated herein that this configuration allows reduction of the moment of inertia of the link actuator. Further, this configuration not only the reduced the inertia, but also reduced the number of components used for the link actuator. This can contribute not only to a reduction in the manufacturing cost, but also to a reduction in resonance of the components.

### INDUSTRIAL APPLICABILITY

The actuator of the present disclosure may be used for a manipulator. For example, the actuator of the present disclosure may be used for a multi-degree-of-freedom manipulator.

The present specification cites the documents including patent applications and manuals of the manufacturers. While the disclosures of such documents are not regarded as being related to patentability of the present invention, such disclosures are incorporated herein by reference in their entirety. More specifically, all of the reference documents are incorporated herein by reference as in the case in which each of the documents is specifically and individually indicated to be incorporated herein by reference.

The embodiments described in the present specification are merely examples to simply describe the present invention. The person skilled in the art can perform a variety of modifications, improvements, and corrections without departing from the scope or the gist of the present invention. All the publications, patents, and patent applications cited in the present specification are directly incorporated herein by reference.

### REFERENCE SIGNS LIST

1 Stator link
2 Rotor link
3 Coil part
4 Magnet part
5 Shaft
6 Bearing

1. An electric motor comprising a first link comprising a stator and a second link comprising a rotor.

2. The electric motor according to claim 1,
wherein the rotor is placed inside the stator, and the rotor rotates inside the stator to move the first link relative to the second link, or
wherein the stator is placed inside the rotor, and the stator rotates inside the rotor to move the first link relative to the second link.

3. The electric motor according to claim 1, wherein the motor is a radial gap motor.

4. (canceled)

5. An actuator comprising the electric motor according to claim 1.

6. The actuator according to claim 5, wherein an end part on the opposite side of the end part where the stator of the first link is present is fixed to another fixing part.

7. The actuator according to claim 5, wherein the end part on the opposite side of the end part where the rotor of the second link is present is fixed to another fixing part.

8. The actuator according to claim 5, wherein a second stator is provided on the end part on the opposite side of the end part where the rotor of the second link is present.

9. The actuator according to claim 5, wherein a second rotor is provided on the end part on the opposite side of the end part where the rotor of the second link is present.

10. The actuator according to claim 5, wherein a second stator is provided on the end part on the opposite side of the end part where the stator of the first link is present.

11. The actuator according to claim 5, wherein a second rotor is provided on the end part on the opposite side of the end part where the stator of the first link is present.

12. The actuator according to claim 8, comprising a third link that comprises a link part in the second rotor rotated by the second stator.

13. The actuator according to claim 9, comprising a third link that comprises a link part in the second stator rotated by the second rotor.

14. The actuator according to claim 5, wherein the actuator according to claim 5 is connected to another actuator in series.

15. The actuator according to claim 5, wherein the actuator is connected to another actuator in parallel.

16. The electric motor according to claim 1, wherein the electric motor does not comprise a gear.

17. A method using the electric motor according to claim 1.

18. A method for manufacturing an electric motor comprising a stator and a rotor, said method comprising:
providing a link part in the stator as a first link; and
providing a link part in the rotor as a second link.

19. The manufacturing method according to claim 18, wherein the motor is a radial gap motor.

20. The manufacturing method according to claim 18, wherein the motor is an axial gap motor.

21. The manufacturing method according to claim 18, wherein the electric motor does not comprise a gear.

22. An actuator comprising the electric motor of claim 1, wherein the actuator does not comprise a gear.
